(19) United States
(12) Patent Application Publication
(10) Pub. No.: US 2007/0130145 A1
(43) Pub. Date: Jun. 7, 2007

(54) User activity based document analysis

(75) Inventors: Elin R. Pedersen, Seattle, WA (US); Jeanine E. Spence, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/286,277

(22) Filed: Nov. 23, 2005

(51) Int. Cl. G06F 17/30

(52) U.S. Cl. 707/9

(57) ABSTRACT

Actions of a user that correspond to various documents are identified by observing and analyzing low level system events driven by the user's interactions with one or more windows for displaying the documents. The identified user activity is used to characterize the documents. Characterizations can include relationships between the documents, and/or importance of the documents, or others.

### BACKGROUND

A number of approaches have been used to try to identify documents that might be of interest or relevant to a user at any given time. One approach has been a task or workflow approach, where documents may be grouped around a central task or workflow, where the user manually defines the task or workflow. However, when different types of applications are used during a task it can be difficult to define a task and discover relations between pieces of information. Structuring of documents, for example using tags and schemas, has also been used to relate documents. However, it can be a burden to structure a document. Some applications may not be capable of understanding the structure, and schemas are often out of date or fail to define structure in a manner suitable for all users.

Another approach has been to relate documents based on common content or keywords. However, this approach often misses document relations or falsely relates documents. This approach may also introduce application dependencies.

Yet another approach for relating documents has been the “property” approach, where properties of documents are manually entered or are discovered by analysis of the documents, and the properties are then used to relate documents. However, manual entry of properties is cumbersome, and automatic property detection may be ineffective and unreliable.

Another approach involves recommending documents to users based on personalized user profiles. If users indicate that a document is of interest, perhaps by selecting it from among a list of search results, or perhaps by repeated accesses to the document, then similar documents with similar or related content may be recommended.

Other approaches have been used. Indexing has also been used to relate documents, for example, by clustering index-related documents. However, indexing does not always reflect the relationships that are most relevant from the perspective of a particular user. Special purpose adapters or agents, which perform document relating tasks for particular documents or applications, have also been used. However, this approach is static and inflexible. For example, if an application is revised, the associated adapter may need to be reprogrammed.

In general, there has been a lack of satisfactory techniques for relating documents.

### SUMMARY

The following summary is included only to introduce some concepts discussed in the Detailed Description below. This summary is not comprehensive and is not intended to delineate the scope of protectable subject matter, which is set forth by the claims presented at the end.

Actions of a user that correspond to various documents are identified by observing and analyzing low level system events driven by the user's interactions with one or more windows for displaying the documents. The identified user activity is used to characterize the documents. Characterizations include relationships between the documents, and/or importance of the documents, or others.

Many of the attendant features will be more readily appreciated by referring to the following detailed description considered in connection with the accompanying drawings.

### DESCRIPTION OF THE DRAWINGS

Like reference numerals are used to designate like parts in the accompanying Drawings.

FIG. 1 shows a process for using user activity as a basis for relating documents.

FIG. 2 shows an embodiment for relating documents.

FIG. 3 shows another embodiment.

FIG. 4 shows an overall process of identifying user actions.

FIG. 5 shows some examples of user activities, events, and interpretations of events.

FIG. 6 shows a general technique for relating documents based on user activity.

FIG. 7 shows examples of techniques for building document relations by relating activity events.

### DETAILED DESCRIPTION

As discussed in the Background, various techniques in the prior art use document content as a basis for relating documents. Documents have also been related based on a task or workflow. Some of the techniques and embodiments described below relate to capturing the activity or effort of a user to relate or rank documents. By using user activity to relate or rank documents, reliable and relevant document relations and rankings can be created. In some embodiments, documents can be related or ranked based on user activity without any dependency on the types of documents or on the types of applications through which user activity is directed to the documents.

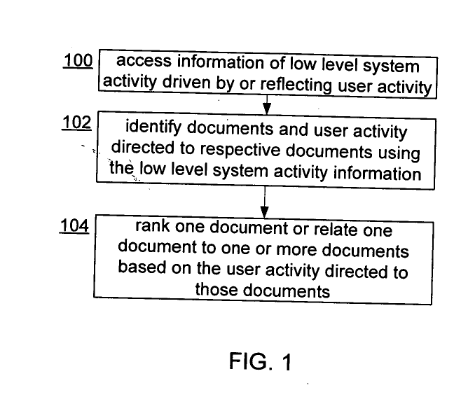

FIG. 1 shows a process for using user activity as a basis for relating documents. The process of FIG. 1 starts by accessing 100 low level system activity driven by or reflecting user activity. As discussed in more detail later, the low level system activity may include windowing activity (e.g., windowing events), file system activity, clipboard activity, etc.

The accessed 100 low level system activity is used to identify 102 documents and user activity directed to the respective documents. The identified user activity corresponds to activity of the user that caused the accessed 100 low level system activity to occur. In other words, the accessed 100 low level system events are translated or mapped to or characterized as higher level user actions directed to or associated with respective documents. The active or target documents may be identified 102 using the low level system activity itself.

The identified 102 document-specific activity is then used 104 to rank one document or relate one document to one or more other documents. For example, if a first user activity of a first document has been identified 102, and a second user activity of a second document has been identified, the first and second activities may be used 104 to relate the first and second document. Or, if a third user activity has been identified 102, that use activity may be used 104 to increase or decrease a rank or importance rating of a document affected or targeted by the activity.

The ranking or relating based on the identified 102 user activities can be understood as modeling the actual activities of a user and how they may be related or how they may indicate what objects (e.g., documents) are significant to the user. Certain types of activities performed by a user are generally assumed to be related, by some degree, in the mind of the user. For example, activities performed by the user (e.g. opening two documents) might be related to a same task or objective of the user, which may be reflected merely by proximity in time of two different identified 102 actions or some identified 102 operations between two documents (e.g. copying and pasting between documents). Although this description discusses certain types of user activities and different ways of relating them, it should be understood that different assumptions about what is related in the mind of a user may call for identifying 102 different types of user activities and different ways of using 104 them to relate the documents to which they pertain. Furthermore, certain types of activities performed by a user are assumed to reflect the subjective importance of documents affected by those activities. For example, altering a document, repeatedly accessing a document, or keeping a document open for extended periods of time might each indicate that the document is important to the user. The specific types of user activities used 104 to rank the importance of a document are not important for the more general idea of simply observing (at a low or system level) the high level activities of a user to draw conclusions about whether a user has given a document some attention or how much attention the user has given the document.

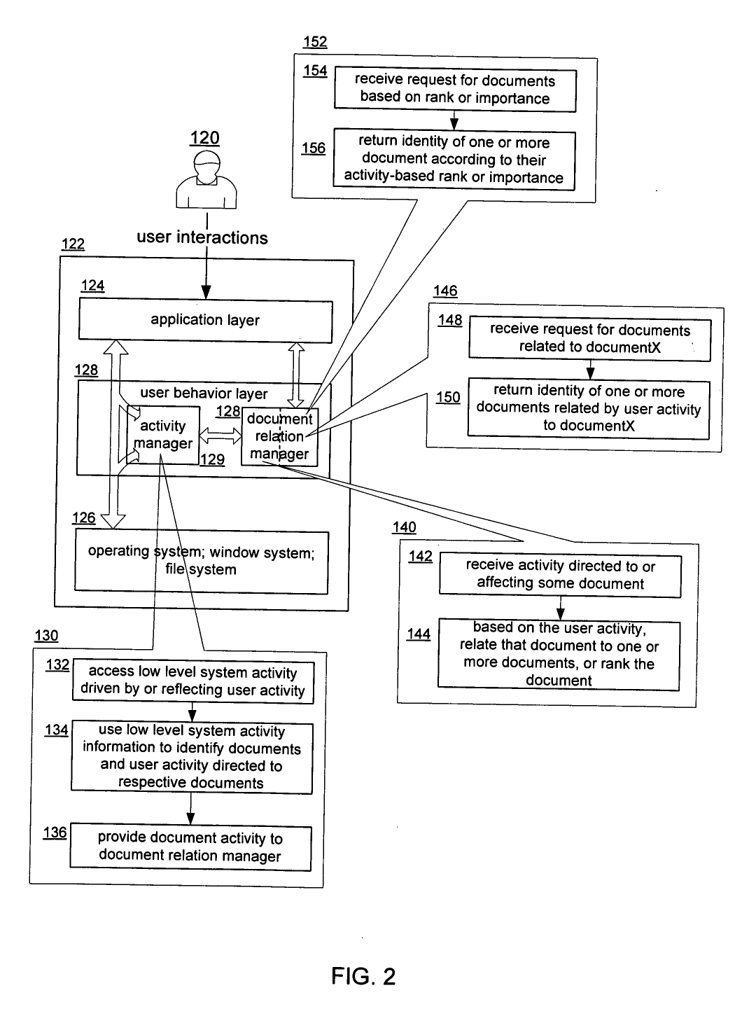

FIG. 2 shows an embodiment for relating and/or ranking documents. A user 120 interacts with a computer 122. The computer 122 may be any type of computing device, such as a workstation, a server, a handheld device, a virtualized computer, and so on. The user may use any type of input device to interact with the computer 122. Specifically, the user's 120 interactions are directed to an application layer 124 in the computer 122. The application layer 124 has one or more applications that rely on lower level systems 126 such as an operating system, a file system, and a windowing system. The operating system may be any present or future operating system, for example any member of the Microsoft Windows family, any Unix-like operating system, and so on. The file system can be of any type, some of which organize and store files and directories, maintain file attributes and file security, coordinate file sharing, and so on. The windowing system may also be of any type, for example, windowing systems such as the X Window System or those found in the Common Desktop Environment, Microsoft Windows, Mac OS, Mac OS X, Palm OS, etc. The windowing system is a system that manages windows and their relationships, displays windows, refreshes the contents of windows, and so forth. Most windowing systems also manage events and dispatch events to individual windows, an event being an asynchronous (usually) notification of an occurrence such as a user action (e.g., a mouse click, a key press/release, a mouse drag), a change in state of a window such as a resize, a change in focus, creation of a window, etc. Most events are associated with one of the managed windows. With most windowing systems, the windowing events have a common event data structure. It should be noted that the windowing system and the file system can be accessed by a network and need not reside on computer 122. The observed events could even be layered on top of underlying windowing and/or file systems. For example, Java events might be monitored within the Java runtime environment, even though those events are implemented by a host system.

Referring again to FIG. 2, a user behavior layer 128 interacts with the application layer 124 and the underlying systems 126. Preferably, the user behavior layer 128 is implemented separate and apart from the application layer 124 and the systems 126. As will be explained, the user behavior layer 128 taps into the communications or interactions between the applications (application layer 124) and the lower level systems 126. The user behavior layer 128 uses these low level communications, events, or interactions to produce relations between documents.

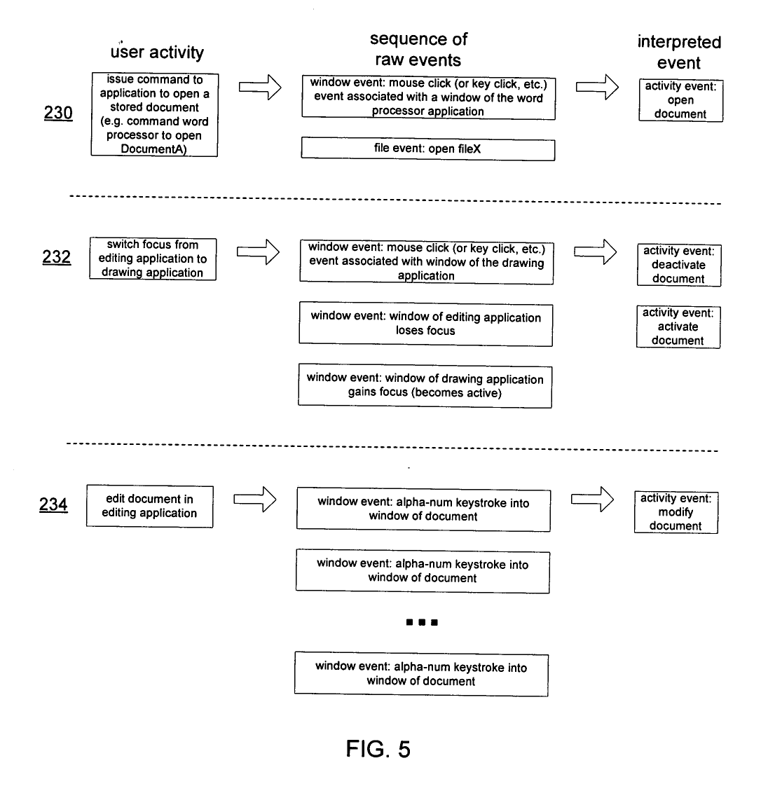

The user behavior layer 128 has an activity manager 129 that performs a process 130 for handling low level events or calls. This process 130 involves obtaining or accessing 130 low level system activities driven by or reflecting user activity (see the right hand side of FIG. 5 for a few simple examples). It is well understood that applications use file systems, windowing systems, etc., and the interaction between applications and these systems are capable of being obtained or accessed 130 by programs or components other than the applications or systems. This can be accomplished in various ways, depending on the type of system. For example, some systems allow callback functions to be attached to certain system calls; when the system call is invoked, the callback function is also invoked and passes on information about the system call. Some windowing systems allow hooks into input events such as mouse and keyboard events, windows events, clipboard events, etc. Other systems allow driver-like modules to be inserted into the system's chain of event processing modules. Regarding the accessing 130 of file system activities or events, the “filemon” utility may be consulted as an example of one technique for tapping into Microsoft Windows based file system activity. For Unix based systems, see, for example, the “tracefs” utility. Details on how to hook windowing events may be found elsewhere. In some systems, cut and paste activity or clipboard activity can be detected by other means, discussed later. The activity manager 129 may store the raw or low level system activity in a log, which can be used to prime the activity manager 129 if it is restarted. The log can also be used to capture activity even if the activity is not being currently used to related documents.

Returning to process 130, the activity manager 129 uses the low level system activity information (e.g. window events, file system events, clipboard operations, etc.) to identify 134 documents and user activity directed to those documents. Several problems may need to be addressed to accomplish this step. First, there may be a need to merge file system events with windowing events. Because there is an interest in user actions on documents, windows are related to documents in order to allow window events to be mapped to documents. Usually it is not difficult to relate a document to a window. Of the current set of windows being managed by the windowing system, many of those windows only provide meta-information (e.g., alerts and dialogs) and their events can be ignored. With other windows, file system events which identify a document can usually be correlated with particular windows (see the discussion of FIG. 5). However, when an application uses dockable or tabbed windows, user activity may be handled by the application itself. In this case, documents can be distinguished (and actions directed thereto) by correlating captured file system events with window events of the application managing the tabbed or dockable windows.

Having established relations between windows and documents, the activity manager 129 can now relate windowing events (and therefore user activity) to particular documents. The incoming event stream for each window/document is monitored, interpreted, and passed on as well-formed or high level events, for example, “open”, “rename”, “copy”, “save as”, “new”, “move document”, “text input”, “cut/copy to buffer/clipboard”, “paste from buffer/clipboard”, “document presence”, etc., each derived from corresponding low level events. The high level document activity is then provided 136 to a document relation manager 138.

The document relation manager 138 is responsible for taking detected high level document activity of a user and determining relations between documents and/or ranking documents. The document relation manager 138 performs process 140 for relating documents, which involves first receiving 142 an activity directed to or affecting some particular document. The document of the received 142 activity is then ranked or related 144 to one or more other documents. The ranking or relating 144 is generally based on the user activity. That is to say the user activity (and therefore the document) is tied to some other documents based on some aspect of the user activity, such as its type (e.g. cut, open, activate, etc.), its time of occurrence, or some piece of information (e.g., a clipboard snippet).

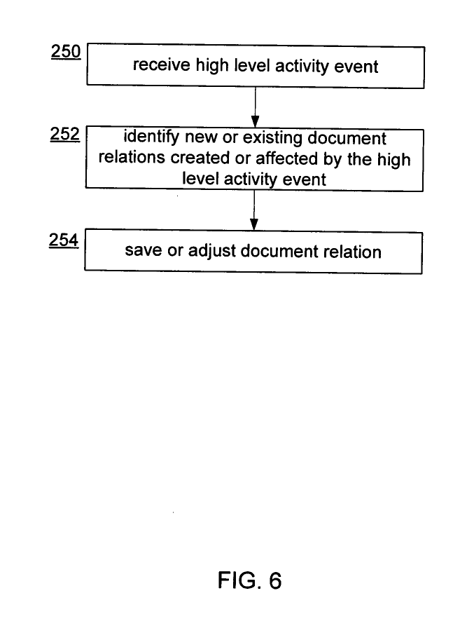

The document relation manager 138 may also manage more than the existence of relations between documents. For example, the document relation manager 138 may maintain or manage relationship strengths, which indicate how close the relationship is between two documents. Details of will be discussed later with reference to FIG. 6.

Another process performed by the document relation manager 128 is a process 146 of providing document relations. When the document relation manager 128 receives 148 a request for documents related to a document (e.g., “documentX”), the identity of one or more documents related by user activity are returned 150. For example, if “documentY” and “documentZ” are related to “documentX”, then those documents are returned 150. Similarly, the document relation manager 128 may perform a process 152 of providing documents based on their activity-based rank or importance to the user. The document relation manager 128 receives 154 a request for documents based on rank or importance. For example, a request might specify return the ten most important documents or the documents with a rank above a specified level. The process 152 returns the identity of one or more documents that satisfy the received 154 request.

The document relation manager 128 may perform other functions. Records of the ranks of documents or the relationships between documents may be maintained. The document relation manager 128 may also maintain records of the various documents that have been related or that have been identified as subjects of user activity. This may involve maintaining (keeping current) filepaths or filenames of documents. If a “rename document” action has been identified, then the document relation manager 128 can change the document's record to reflect the new filepath or filename. If a “delete document” action has been identified, the document relation manager 128 may delete the corresponding document relationships.

A notable aspect of the user behavior layer 128 is that it is transparent to the user. The activity monitoring and document relating may occur without interrupting the user. Furthermore, if document ranking or relation processing is performed as soon as user activity is identified, the activity-based document relations/rankings can be provided in real time to reflect to user's most recent activity. In another embodiment, document relations/rankings (and even how they are determined) may develop gradually as information about user activity accumulates and rankings and/or relations between documents perhaps become increasingly reliable.

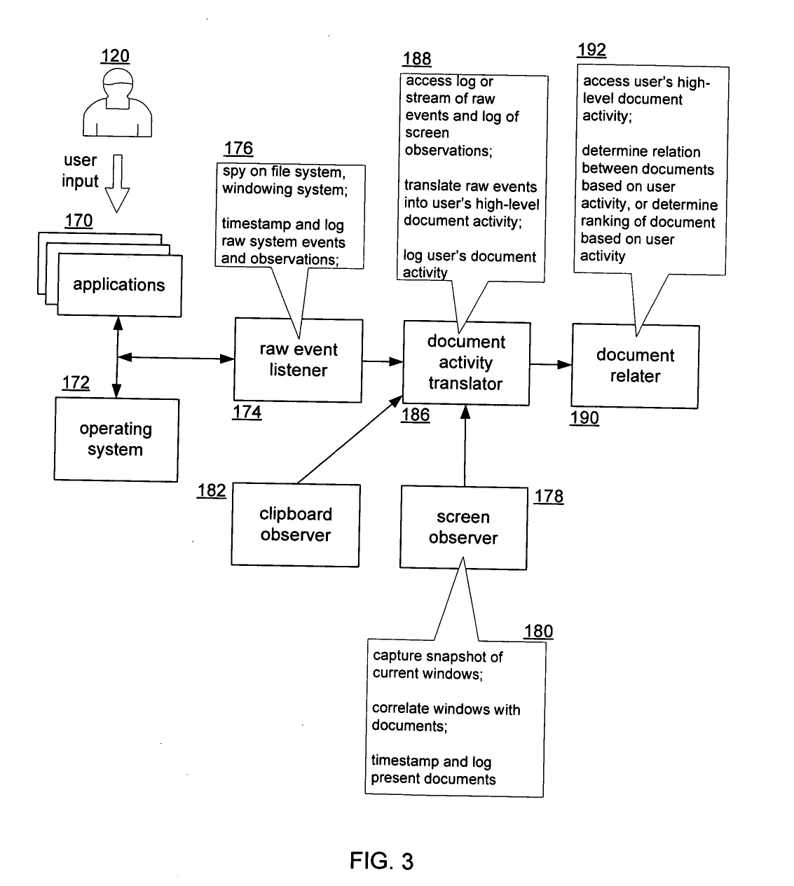

FIG. 3 shows another embodiment. User 120 controls or interacts with the graphical user interfaces of applications 170. The applications 170 interface with the operating system 172, which is presumed to include window management functionality and file management functionality. A raw event listener 174 performs a process 176 of spying on the file system and window system activity that occurs as a result of the user's 120 interactions with the applications 170. Because the file and/or windowing interactions between the applications 170 and the operating system 172 may be asynchronous, the spied file interactions and/or windowing interactions are preferably timestamped, which may help map spied interactions to high level activities.

In the embodiment shown in FIG. 3, another information collector, a screen observer 178, performs a process 180 of capturing snapshots of current windows, correlating the windows with documents, and logging these screen observations. This process 180 may be repeated periodically to repeatedly ascertain the state of windows and documents. Captured observations may be, for example, open windows/documents, visibly displayed windows/documents, closely located windows/documents, etc. A document activity translator 182 performs a process 184 of accessing the log or stream of raw system events, translating these system events into high level document activity, and logging the same. A document relater 186 performs a process 188 of accessing the high level user activity and using it to determine the existence and/or strength of relations between documents. Although the screen information captured by the screen observer 178 need not be driven by a user action, it reflects a form of user activity. For example, when a user keeps two documents open and close to each other and visible on the screen for a prolonged time, that choice is a form of action (arranging windows), which indicates that the user may find the documents subjectively related. The converse may also be true.

The embodiment shown in FIG. 3 may also include a clipboard observer 182. The manner of acquiring clipboard activity will likely vary according to the computing environment. The following process will work in a Microsoft Windows environment. The user's cut/copy/paste operations are effected through a Clipboard Viewer Window. A capture driver calls Clipboard APIs to effect this functionality. The capture driver: (1) creates the Clipboard Viewer Window, which is added to the “Clipboard Viewer Chain”; (2) when the Clipboard is changed, the operating system 172 calls the Viewer callback; and (3) the Viewer callback extracts a copy of the change and determines which window currently owns the Clipboard focus; (4) determines associated Process ID and owner of the window; and (5) timestamps this information and writes it to a log file. Given the log file, any other component (for example the activity translator 186) can: (1) discover that a new Clipboard log record exists; (2) optionally filter the clipboard operation record based on the application that generated it; (3) compare the clipboard operation with other recent clipboard operations (e.g., the previous 20); and pass on a new clipboard operation with gathered relationship data (either with or without the actual cut/copy/paste contents).

Returning to FIG. 3, a document activity translator 186 receives various observational data, for example, from the raw event listener 174, the screen observer 178, and/or the clipboard observer 182. The document activity translator 186 performs a process 188 of accessing the observational data (low level events) from the various observers or listeners, translates those events into high-level document activity, logs the user's document activity. The high-level document activity may be passed to a document relater 190 either directly or by way of the activity log. The document relater 190 performs a process 192 of accessing the high-level user document activity and using it to determine relations between documents or to rank the importance of documents.

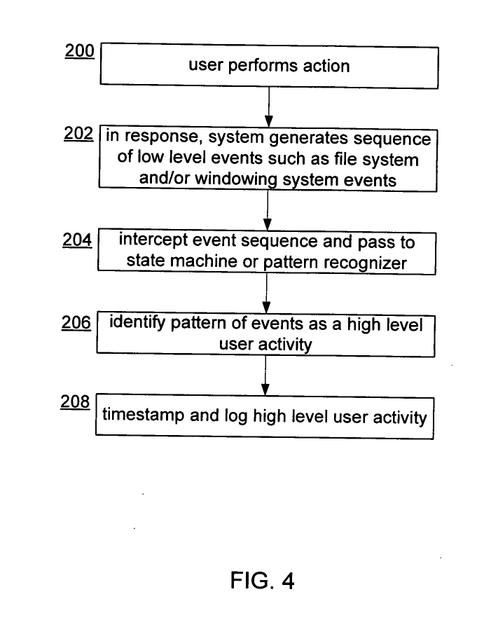

FIG. 4 shows an overall process of identifying user actions. Initially, a user performs an action 200, such as opening a document, activating a document/window, copying from a document/window to a clipboard, directing input to a document/window (e.g. inputting text or performing a drag operation), etc. In response to an action 200, a sequence of one or more low level events may be generated 202 by the operating system and/or the file system, and/or the windowing system. These events are intercepted 204 and passed to a state machine or pattern recognizer, which identifies 206 patterns in the events, a pattern corresponding to high a level activity or action 200. The identified 206 high level user activity is then timestamped and logged for use in relating documents.

FIG. 5 shows some examples of user activities, events, and interpretations of events. User activity 232 is the issuance by a user of a command to open a document. This generates raw events such as a mouse click and a file-open event. A state machine, pattern recognizer, or the like, recognizes the sequence of the events and determines that the user has performed a document-open action. User activity 232 is the switching of focus from one application/document to another application/document. A mouse-click event, a lose-focus event, and a gain-focus event are generated. The sequence is recognized, possibly based on the proximity of the types of the events, or possibly based on the order of the types of the events, and corresponding high-level actions are identified. The deactivate action and activate action could also be consolidated as one action. User action 234 is editing a document by inputting text to the document. This is manifested as a sequence of keystroke window events, which can also be recognized and interpreted as an activity of using or editing the document.

There is practically no limit on how identified user activity can be used to relate or rank documents. FIG. 6 shows a general technique for relating documents based on user activity. A high level event is received 250, for example, an edit-document event. New relations arising from the event, or existing relations affected by the event are, respectively, or created or identified 252. How this is accomplished may depend on the type of user activity. For example, in the case of an edit-document event, existing relations of the edited document might be strengthened if those relations were based on a time or screen proximity event that has not ended. Or, in the case of an activate-document event, a relation with the correspondingly deactivated document may be created or strengthened. The one or more identified 252 relationships are then saved, deleted, or adjusted (strengthened or weakened) 254.

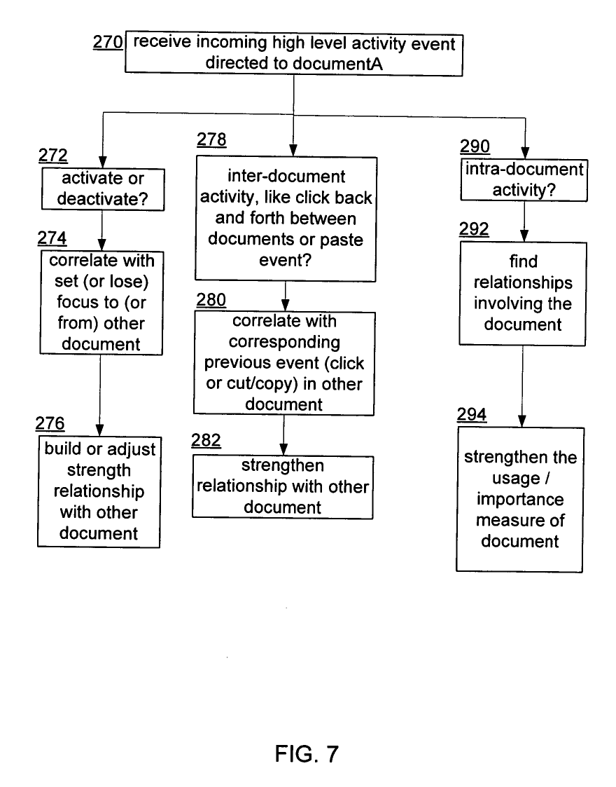

FIG. 7 shows examples of techniques for building document relations by relating activity events. The examples in FIG. 7 are only illustrative. It should be understood that there are many ways that relationships can be derived based on user activity. If a screen presence event 272 is received, the event is correlated 274 with presence events of other documents, and relationships with those documents are built (deleted) or strengthened (weakened) based on the degree of co-existence with those documents. If a cut or paste event 278 is received, the event is correlated 278 with the source or target document, and a relation between those two documents is either established or strengthened 282. If an activate or deactivate event 284 is received, then the event/document is correlated 286 with the corresponding deactivated or activated document and a relationship between the documents is built or strengthened 288. As another example, if a document activity event 290 (e.g. editing or modifying a document) is received, then relationships involving the document are found 292 and strengthened 294. Other types of actions can also be detected and used. For example, drag and drop between documents can indicate a strong relationship between the involved documents. Drag and drop can also be detected as a corresponding stream of particular windowing events.

A number of refinements can be used to improve the reliability of relationships. If a document-close event occurs immediately after an open event, then a relation effect from the open event might be undone or ignored. A cluster of click events might increase the weight of a relationship. Recurrence of a document-relating event can serve to strengthen a relationship, and newer such events can be given more weight than initial events. Furthermore, documents can be provided with an importance factor, adjusted over time, that affects the relationships of the document.

To avoid an over-accumulation of relationships over time, it may be helpful to include a mechanism for culling or weakening relationships or document importance ratings. For example, if a relationship is not used or strengthened over some given period of time, the relationship can be deleted or repeatedly weakened until deleted. Or, if there is no activity directed to a document over time, then that document's importance and/or relationships can similarly be weakened or removed. It is even possible to use user activity as a direct basis for weakening or removing relationships. For example, closing a first group of one or more documents and then opening a second group of one or more documents may be taken as a sign that the documents in those groups are not related and any relations between the groups can be weakened or removed.

Although FIG. 7 relates to document relationships, a similar approach may be used for building and maintaining document rankings or importance. However, rather than correlating 274, 280, 286, 292 and building/strengthening 276, 282, 288, 294, an event with related documents, the incoming event is used to update the importance or rank of the document with which it is associated. Each type of even may have its own algorithm for determining a document's importance based on events of that type. For example, importance can be scaled in direct proportion to the length that a document is present on a screen. Activity such as editing a document might be given much greater weight than other types of activities.

In one embodiment, a history of activity events is stored and used to help compute document relations and/or rank/importance. That is to say, a history of the events that caused changes in a document's rank and/or its relationships is stored and then used when computing a rank or relationship. This allows complex algorithms to be used. For example, cycles of activity might be detected (e.g., a document is accessed every Thursday) and taken into account when computing a rank or relationship strength.

As used herein, the term “document” refers to any unit or container of information usually corresponding to some file, resource associated with a resource locator, or the like. A document can be a unit of information that is often viewed or manipulated in an application window. Some examples of documents are word processor documents, graphics documents, slide presentations, emails, static or dynamic web pages, database views, programming projects or source code files, and others.

Implementations based on the explanations above, insofar as they observe and interpret a computer's low level system activity which is generated for any application or program on a computer, can generate relations between documents without regard for the application that is manipulating the document, without regard for the type of document, and without regard for the content of the document. A well designed implementation can relate documents for applications that only come into existence even after such implementation is complete. Applications do not need to be modified, and special adapters should not be needed. Furthermore, any of the embodiments discussed above can also be used in conjunction with a content-based approach for relating documents. In other words, user activity can serve as a basis to supplement other types of document relating.

It should be appreciated that the very determination of a relationship is itself a useful result. Once document relationships have been ascertained, there are a number of ways they can be used. Relationships can be used to enhance a user interface. For example, if a document window of a word processor might display some indicia of related documents. The indicia might be ordered by the strength of their relationship with the document, and might also be displayed in a manner to indicate whether they are presently open, etc. Document relations can also be used to improve a document searching process, whether server or desktop based. In the case of a search engine, relations passed to the search engine can be used when performing a search. In the case of a desktop search, a desktop search engine can use document relations to help order search results or to display documents related documents found in a search, and so on. Document relations can be used for backup purposes. If a document is backed up, any related documents might also be backed up with it. Other uses abound.

In some of the examples above, the mechanism for using the document relations can also serve as a channel for strengthening document relations. For example, if an interface element displays a list of documents related to the active document and the user uses that list to activate or open one of the related documents, the interface element could provide feedback to the relationship manager that the relationship manager can use to strengthen that particular relationship. Or, if a document is listed in a search result based on a relationship, and that document is the selected by the user, that selection can strengthen the relationship.

Although user activity is useful for determining the importance of documents or relationships between documents, in general documents need not be the only types of things that can be related or characterized based on user activity. Any type of object that a user can discretely view, create, manipulate, etc. can be related or characterized. Furthermore, importance of objects and the relationships between objects are not the only kinds of information that can be determined. An object can in other ways be characterized according to a user's activity that affects or touches upon the object. For example, an object or document can be categorized or typed based on how it is used. Some forms of activity may indicate that an object is a “reference” type of object, i.e., an object that a user refers to often but does not modify often. Other forms of activity may indicate that an object is an “update” type of object.

In conclusion, those skilled in the art will realize that storage devices used to store program instructions can be distributed across a network. For example a remote computer may store an example of a process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art, all or a portion of the software instructions may be carried out by a dedicated circuit, such as a DSP, programmable logic array, or the like.

All of the embodiments and features discussed above can be realized in the form of information stored in volatile or non-volatile computer or device readable medium. This is deemed to include at least media such as CD-ROM, magnetic media, flash ROM, etc., storing machine executable instructions, or source code, or any other information that can be used to enable or configure computing devices to perform the various embodiments discussed above. This is also deemed to include at least volatile memory such as RAM storing information such as CPU instructions during execution of a program carrying out an embodiment.

1. One or more volatile or non-volatile device readable media storing information to allow a device to perform a process, the process comprising:
automatically identifying actions of a user that correspond to various documents by observing and analyzing low level system events driven by a user's interactions with one or more windows for displaying the documents; and
using the identified user activity to automatically determine characteristics of the documents.

2. One or more volatile or non-volatile device readable media according to claim 1, where the process further comprises:
storing indicia of the identified user activity in relation to specific documents; and
using the indicia of the user activity to relate a first document with a second document or to determine an importance of a document.

3. One or more volatile or non-volatile device readable media according to claim 1, wherein the characteristics comprise relationships between documents, and the relationships include respective weights that indicate strengths of the relationships.

4. One or more volatile or non-volatile device readable media according to claim 1, wherein the low level system events comprise file system events passing to and/or from a file system for managing files and windowing events passing to and/or from a windowing system for managing windows.

5. One or more volatile or non-volatile device readable media according to claim 1, wherein the process further comprises displaying document information based on one or more of the characteristics.

6. One or more volatile or non-volatile device readable media according to claim 5, wherein: the characteristics comprise relationships between documents and/or importance ratings of documents, the low level system events are translated into high level user actions, and the high level user actions are used to produce the relationships and/or importance ratings.

7. A device configured to perform a process for automatically ranking and/or relating documents, the process comprising:
in response to a user's interactions with windows of respective documents, exchanging windowing events and file system events between applications or programs hosting the windows and a windowing system and a file system; and
capturing or observing the windowing events and file system events of the different applications or programs and using the windowing events and file system events to automatically generate relationship information comprising relationships between the documents and/or to automatically generate importance information comprising information indicating importance of the documents.

8. A device configured according to claim 7, wherein a relationship comprises a relationship between a first of the documents and a second of the documents, and wherein the relationship was generated by relating a first user interaction with the first document and a second user interaction with the second document.

9. A device configured according to claim 7, wherein the process further comprises capturing or observing first windowing and/or file system events corresponding to an action by a user upon or affecting a document, retrieving an existing relationship of the document, and modifying, or deleting, or strengthening, or weakening the relationship based on the first windowing and/or file system events.

10. A device configured according to claim 8, wherein a user interaction comprises cutting (or copying) and pasting between documents, switching from one active document to another document, or having documents open at the same time, and the user interaction is used to generate or strengthen a relationship between those documents.

11. A device according to claim 10, wherein another user interaction comprises working on a document, and that user interaction is used as a basis to strengthen a relationship of that document.

12. A device according to claim 7, wherein a relationship or importance of a document is strengthened and/or weakened over time based on a stored history of activity directed to or affecting the document.

13. A device according to claim 8, wherein a document relationship is strengthened with repeated occurrences of a same user activity on the document.

14. A method for a computer to automatically determine relations between different documents and/or importance of documents, the method comprising:
observing low level system events exchanged between application programs and one or more systems that provide file and window management functionality to programs running on the computer, where each application comprises at least one window for displaying a different one of the documents, and where the low level system events are exchanged in response to actions of a user affecting the windows;
using observed low level system events to determine which windows display which of the documents; and
using observed low level system events and the determination of which windows display which documents to determine importance of documents and/or relationships between the documents.

15. A method according to claim 14, further comprising identifying the actions of the user using the low level system events, and using those identified actions to determine the relationships and/or importance.

16. A method according to claim 15, wherein the identified actions comprise switching between windows/documents, or cutting (or copying) and pasting between windows/documents, or dragging and dropping between documents.

17. A method according to claim 14, wherein the relationships comprise respective strength indicators, and where the identified actions are used to strength and weaken the relationships.

18. A method according to claim 15, wherein inactivity of a document or activity affecting a document is used as a basis for increasing or reducing the strength of a relationship of that document or the importance of that document.

19. A method according to claim 14, further comprising receiving a request that identifies a document, and using the relationships to return indications of one or more documents related to the requested document.

20. A method according to claim 14, further comprising periodically capturing information about which windows and their documents are currently open, and using that information in determining the relationships between the documents.
